(19) United States
(12) Patent Application Publication
(10) Pub. No.: US 2002/0130438 A1
(43) Pub. Date: Sep. 19, 2002

(54) Hot bending of a thermoplastic workpiece

(76) Inventors: Arno Jambor, Vaihingen (DE); Michael Bechtold, Monsheim (DE); Erwin Fauser, Tubingen (DE)

Correspondence Address: KENYON & KENYON, ONE BROADWAY, NEW YORK, NY, 10004, US

(21) Appl. No.: 10/075,942

(22) Filed: Feb. 13, 2002

(30) Foreign Application Priority Data
Feb. 16, 2001 (DE) 101 07 224.4

(51) Int. Cl. B29C 53/04

(52) U.S. Cl. 264/296; 264/322; 264/339; 425/383

(57) ABSTRACT

A method for bending a largely plate-shaped, thermoplastic workpiece, e.g., a sandwich panel, the bending region of the workpiece, heated at least up to plasticization, being bent about a bending element acting upon the workpiece. The bending element is pushed into the workpiece up to the apex of the desired bending, and the bending is performed about the front end, viewed in the insertion direction, of the inserted bending element.

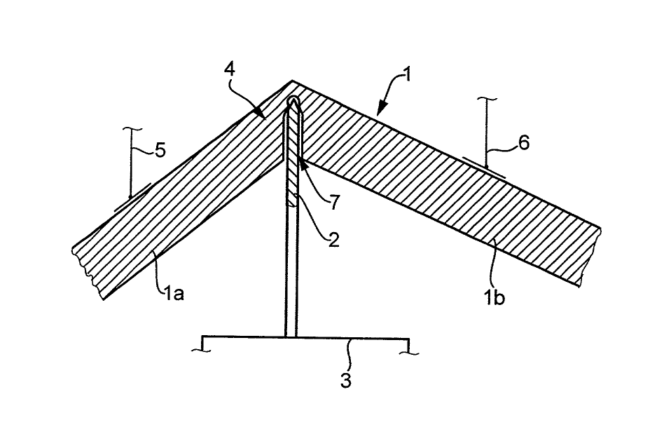

### FIELD OF THE INVENTION

The present invention relates to a method for bending an essentially plate-shaped, thermoplastic workpiece, e.g., a sandwich panel, the bending region of the workpiece heated at least to plasticization being bent about a bending element acting upon the workpiece, as well as to a suitable bending arrangement for carrying out this method.

### BACKGROUND INFORMATION

The bending of thermoplastic workpieces, especially of sandwich panels, heightens their applicability as building elements in various fields. Even after manufacturing of the panels, by bending, any theoretical angle may be produced, and using multiple bending, even polylines.

A method is described in European Published Patent Application No. 0 456 121, in which a workpiece, heated to plasticization, is bent about a bending element lying adjacent to the workpiece, further heat being supplied to the workpiece during the bending procedure. In this connection, the bending element can also be designed as a heating sword. In this method, the cross-section of the workpiece decreases in the region of the bend, which, especially in workpieces of greater thickness, leads to reduced strength. On the outer side of the bending region there is also the danger of tearing of the outer skin of the workpiece.

German Published Patent Application No. 196 24 41 describes a method which avoids these disadvantages. A V-shaped groove is removed from the panel, mechanically or using a heating sword, and the panel is bent by guiding the lateral side pieces of the groove together. In this case, not only is the work effort considerable. If the groove is produced by melting using the heating sword, the shape of the groove and therewith also the bending angle are predefined of necessity by the shape of the heating sword. The possibility of (implementing) variations according to current requirements can here no longer be realized, especially not if the need for a different opening angle is only recognized during the bending (procedure).

It is an object of the present invention to provide a method with which, while largely avoiding a strength reduction of the workpiece, and at minimal cost, a bending angle may be achieved which may substantially be selected at will.

It is another object of the present invention to provide a bending arrangement suitable for performing this method.

### SUMMARY

The above and other beneficial objects of the present invention are achieved by providing a method and an arrangement as described herein.

In a method according to one example embodiment of the present invention, the bending element is pushed into the workpiece up to the apex of the desired flexure, and bending about the front end, in the pushed-in direction, of the pushed-in bending element.

Because of the bending about the bending element pushed into the workpiece, the apex of the flexure is closer to the outside of the bending region, whereby, in comparison to the total thickness of the workpiece, a narrow region is subjected to stretching. Because of that, the stretching acting on this region is also less. This is especially true for the outer side of the bending region.

The bending element may be heated, whereby both heating the workpiece at least partially via the bending element may occur, and also pushing the bending element into the workpiece is made easier.

Further, after bending, the bending element may be moved out of the workpiece so that the gap created in the workpiece by pushing in the bending element is sealed together again. The work piece may be stressed again without further aftertreatment.

This may be repeated at various locations along the workpiece for creating a polyline. A polyline that is largely formed at will may be generated, and along with that, a product of great flexibility.

For performing this method, in a bending arrangement, the bending element may be heated at least in the region penetrating the workpiece, and has a suitable shape on this side for being pushed into the at least plasticized workpiece. The bending element may be pushed into the workpiece to the desired depth, and the workpiece is plasticized at least partially by the energy given off by the bending element.

The bending element may include a flat bar over the side edge of which the workpiece may be bent in a simple manner. The bending element may be formed as a tube.

Further advantages and features of the present invention may be inferred from the example non-limiting embodiment illustrated in the drawing.

### BRIEF DESCRIPTION OF THE DRAWING

The FIGURE illustrates, partially in cut-off and partially in a broken-away illustration, a bending arrangement in the bending position.

### DETAILED DESCRIPTION

On a workpiece 1, a flat bar 2 is positioned as the bending element. Flat bar 2 is displaceably positioned on a workbench 3, in a plane perpendicular to workpiece 1 and is heatable at least at its upper part which penetrates the workpiece. A region 4 of workpiece 1, in which bending is to occur, is heated via heatable part 2a of flat bar 2 at least to plasticization. Alternatively or in supplement, heating may also be performed by an additional source of energy, such as a laser. On the side of the workpiece facing away from flat bar 2, on both sides of bending region 4 devices 5 and 6 are provided, with which a pressure force may be exerted in the direction of the arrows on workpiece 1, so that it is bent over the upper end of flat bar 2, the regions to the right and to the left of the bending point, determined by the flat bar, being denoted as lateral side 1a and 1b of workpiece 1. The region adjacent to the front end, in the push-in direction, of flat bar 2 during the bending procedure is designated as the apex of the flexure. The structures and fibers of this apex are virtually not stressed by the bending.

The bending may also be performed by hand, instead of by using devices 5 and 6. Removal of the flat bar from the workpiece after bending has occurred is to be performed so 10 that gap 7, formed by guiding it in, is sealed again. For this purpose, at the appropriate energy supply which ensures the plasticization of the regions of lateral sides 1a and 1b directly adjacent to the flat bar, the lateral sides are further pressed together, so that they are guided together 1st behind the flat bar moving out of the workpiece, so as to close gap 7.

After the close of the bending procedure, the workpiece may be bent in several steps at further locations in the same manner, so as to receive the intended shape. If the flexures are executed in a plurality of steps and parallel to one another in each case, by forming polylines, even very large arches may be produced.

What is claimed is:

1. A method for bending a substantially plate-shaped, thermoplastic workpiece, comprising the steps of:
heating a bending region of the workpiece at least up to plasticization;
inserting a bending element into the workpiece up to an apex of a desired bend; and
bending the bending region about the bending element acting on the workpiece about a front end, relative to an insertion direction, of the inserted bending element.

2. The method according to claim 1, wherein the workpiece includes a sandwich panel.

3. The method according to claim 1, further comprising the step of heating the bending element.

4. The method according to claim 1, further comprising the steps of:
moving the bending element out of the workpiece after the bending step; and
sealing a gap that was created in the workpiece by the bending element in the inserting step.

5. The method according to claim 1, further comprising the step of repeating the heating, inserting and bending steps a plurality of times at various locations along the workpiece to generate a polyline.

6. A bending arrangement for hot bending a thermoplastic workpiece by a method that includes the steps heating a bending region of the workpiece at least up to plasticization, inserting a bending element into the workpiece up to an apex of a desired bend and bending the bending region about the bending element acting on the workpiece about a front end, relative to an insertion direction, of the inserted bending element, comprising:
a bending element heatable at least in a region configured to penetrate the workpiece and having a suitable shape configured for insertion into the at least plasticized workpiece.

7. The arrangement according to claim 6, wherein the bending element includes at least one of a flat bar and a tube.
